(19) United States
(12) Patent Application Publication
(10) Pub. No.: US 2013/0157245 A1
(43) Pub. Date: Jun. 20, 2013

(54) ADAPTIVELY PRESENTING CONTENT BASED ON USER KNOWLEDGE

(71) Applicants: Sumit Basu, Seattle, WA (US); Lucretia H. Vanderwende, Sammamish, WA (US); Lee Becker, Boulder, CO (US)

(72) Inventors: Sumit Basu, Seattle, WA (US); Lucretia H. Vanderwende, Sammamish, WA (US); Lee Becker, Boulder, CO (US)

(73) Assignee: MICROSOFT CORPORATION, Redmond, WA (US)

(21) Appl. No.: 13/327,324

(22) Filed: Dec. 15, 2011

(51) Int. Cl. G09B 7/00

(52) U.S. Cl. 434/362

(57) ABSTRACT

One or more automatically generated questions regarding subject matter of a body of text are presented (e.g., displayed) to a user. A user input of one or more answers to the one or more automatically generated questions is received, and the body of text is presented to the user, adapted based on a correctness of the one or more answers. The body of text is adapted to emphasize portions of the body of text that are estimated as not having been mastered by the user based on estimated probabilities of user mastery of the various portions of the body of text generated based on the correctness of the one or more answers.

### BACKGROUND

As computing technology has advanced and computers have become increasingly interconnected, the amount of information readily available to users has increased. Although such information is readily available to users, the user is typically able to learn the information only by reading or otherwise playing back the information. There are oftentimes no formal classes to teach the users the information, or such classes are inaccessible (e.g., due to scheduling conflicts, costs, etc.). Accordingly, although large amounts of information are available to users, it remains problematic for users to learn the information.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, one or more automatically generated questions regarding subject matter of a body of text are presented (e.g., displayed) to a user. A user input of one or more answers to the one or more automatically generated questions is received, and the body of text is presented to the user, adapted based on the correctness of the one or more answers.

### BRIEF DESCRIPTION OF THE DRAWINGS

The same numbers are used throughout the drawings to reference like features.

FIG. 1 is a block diagram illustrating an example environment implementing the adaptively presenting content based on user knowledge in accordance with one or more embodiments.

FIG. 2 illustrates an example system implementing the adaptively presenting content based on user knowledge in accordance with one or more embodiments.

FIG. 3 illustrates an example flow diagram for the adaptively presenting content based on user knowledge in accordance with one or more embodiments.

FIG. 4 illustrates an example adaptive content management system in accordance with one or more embodiments.

FIG. 5 illustrates an example of fill-in-the-blank questions that can be presented to one or more human judges in accordance with one or more embodiments.

FIG. 6 is a flowchart illustrating an example process for adaptively presenting content based on user knowledge in accordance with one or more embodiments.

FIG. 7 illustrates an example computing device that can be configured to implement the adaptively presenting content based on user knowledge in accordance with one or more embodiments.

### DETAILED DESCRIPTION

Adaptively presenting content based on user knowledge is discussed herein. A body of text, such as one or more articles, is obtained and displayed or otherwise presented to a user. Portions, such as sentences, of the body of text are automatically selected and questions regarding the subject matter of the body of text are automatically generated from the selected portions. User answers to the questions are received and the correctness of the user answers is determined. An estimate of which parts of the body of text the user understands and which parts the user does not understand is made based on the correctness of the user answers. At least part of the body of text is then displayed or otherwise presented to the user with particular portions emphasized based on this estimate. The emphasis can be performed in different manners, such as highlighting the particular portions in the body of text, displaying only the particular portions of the body of text, and so forth. This questioning and displaying of particular portions of the body of text with particular portions emphasized can optionally be repeated until a threshold level of mastery of the subject matter has been demonstrated by the user.

Additionally, the portions of the body of text can be automatically selected and questions automatically generated from the selected portions prior to displaying or otherwise presenting the body of text to the user. Thus, the initial display or presentation of the body of text to the user can be adapted to emphasize the particular portions of the body of text that it is estimated the user does not understand. The questioning and displaying of the body of text adapted to emphasize particular portions of the body of text can optionally be repeated until a threshold level of mastery of the subject matter has been demonstrated by the user.

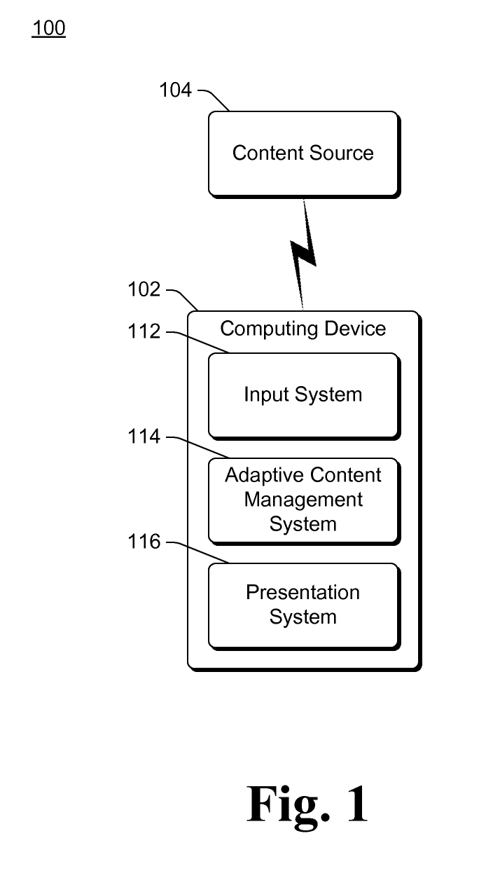

FIG. 1 is a block diagram illustrating an example environment 100 implementing the adaptively presenting content based on user knowledge in accordance with one or more embodiments. Environment 100 includes a computing device 102 and a content source 104. Computing device 102 can be a variety of different types of devices, such as a physical device or a virtual device. For example, computing device 102 can be a physical device such as a desktop computer, a server computer, a laptop or netbook computer, a tablet or notepad computer, a mobile station, an entertainment appliance, a set-top box communicatively coupled to a display device, a television or other display device, a cellular or other wireless phone, a game console, an automotive computer, and so forth. Computing device 102 can also be a virtual device, such as a virtual machine running on a physical device. A virtual machine can be run on any of a variety of different types of physical devices (e.g., any of the various types listed above).

Content source 104 is a source of content that is used by computing device 102, as discussed in more detail below. Content source 104 can take various forms, such as a storage device, a service providing content (e.g., implemented by one or more services that can be a variety of different types of devices analogous to computing device 102), and so forth. Content source 104 can be coupled to computing device 102 using a variety of different networks, including the Internet, a local area network (LAN), a public telephone network, an intranet, other public and/or proprietary networks, combinations thereof, and so forth. Content source 104 can also be coupled to computing device 102 in other manners other than a network, such as via a wired connection (e.g., a universal serial bus (USB) connection or IEEE 1394 connection) and/or wireless connection (e.g., a wireless USB connection or infrared (IR) connection).

Computing device 102 includes an input system 112, an adaptive content management system 114, and a presentation system 116. Input system 112 receives user inputs from a user of computing device 102. User inputs can be provided in a variety of different manners, such as by pressing one or more keys of a keypad or keyboard of device 102, pressing one or more keys of a controller (e.g., remote control device, mouse, trackpad, etc.) of device 102, pressing a particular portion of a touchpad or touchscreen of device 102, making a particular gesture on a touchpad or touchscreen of device 102, and/or making a particular gesture on a controller (e.g., remote control device, mouse, trackpad, etc.) of device 102. User inputs can also be provided via other physical feedback input to device 102, such as tapping any portion of device 102, bending device 102, an action that can be recognized by a motion detection component of device 102 (such as shaking device 102, rotating device 102, etc.), and so forth. User inputs can also be provided in other manners, such as via audible inputs to a microphone, via motions of hands or other body parts observed by an image capture device, and so forth.

Presentation system 116 presents content, including content adapted by adaptive content management system 114. Presentation system 116 typically presents content by displaying the content, although presentation system 116 can present content in other manners, such as playing back content audibly via a speaker of (or coupled to) computing device 102. Content is typically displayed by presentation system 116 on a screen of computing device 102, although presentation system 116 can alternatively send signals to a separate device having a screen for display of the content.

Adaptive content management system 114 manages adapting content obtained from content source 104 for a user of computing device 102. This adaptation includes automatically generating questions for the user, and determining parts of the content to emphasize based on the answers to those questions, as discussed in more detail below.

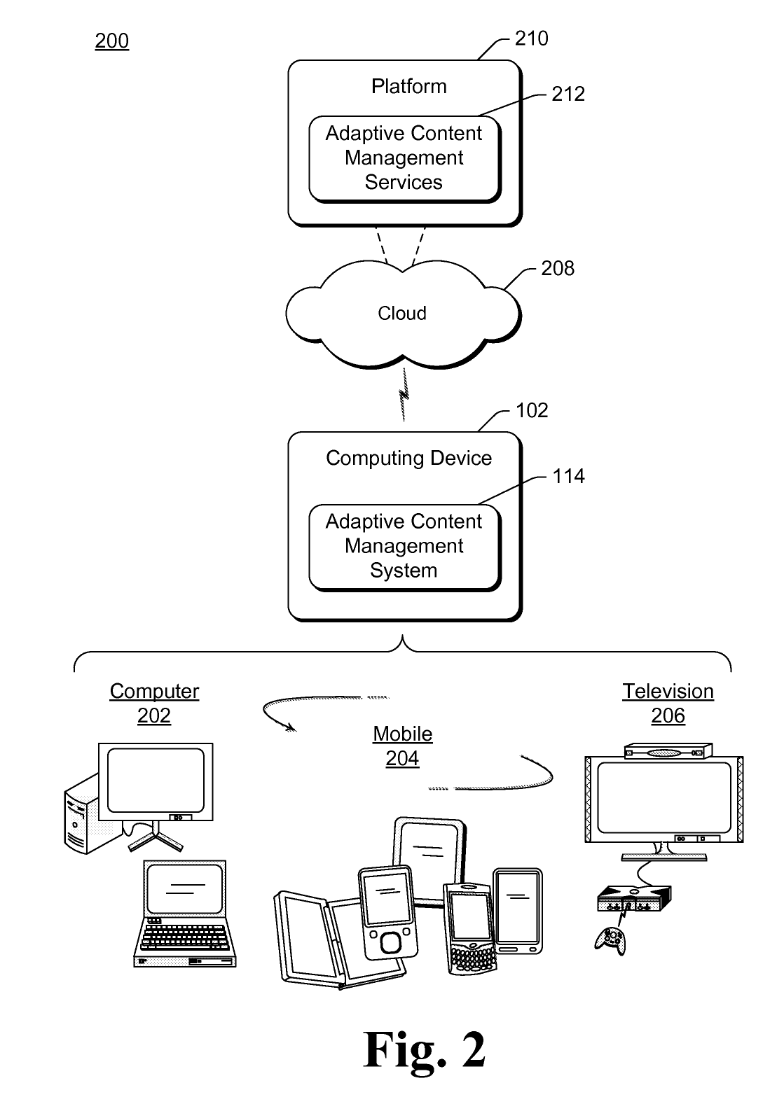

FIG. 2 illustrates an example system 200 that includes computing device 102 of FIG. 1. The example system 200 enables ubiquitous environments for a seamless user experience when running applications on any type of computer, television, and/or mobile device. Services and applications run substantially similar in all environments for a common user experience when transitioning from one device to the next while utilizing an application, playing a video game, watching a video, listening to music, viewing content, and so on.

In the example system 200, multiple devices can be interconnected through a central computing device, which may be local to the multiple devices or may be located remotely from the multiple devices. In one embodiment, the central computing device may be a cloud of one or more server computers that are connected to the multiple devices through a network, the Internet, or other data communication link. In one or more embodiments, this interconnection architecture enables functionality across multiple devices to provide a common and seamless experience to a user of the multiple devices. Each of the devices may have different physical requirements and capabilities, and the central computing device uses a platform to enable delivery of an experience that is both tailored to a particular device and yet common to all of the devices. In one embodiment, a class of target devices is created and user experiences are tailored to the generic class of devices. A class of devices may be defined by physical features, types of usage, or other common characteristics of the devices.

In various implementations, computing device 102 may be implemented in a variety of different configurations, such as for computer 202, mobile 204, and television 206 uses. Each of these configurations includes devices that may have generally different constructs and capabilities, and the client device may be configured according to one or more of the different device classes. For example, the client device may be implemented as any type of a personal computer, desktop computer, a multi-screen computer, laptop computer, tablet, netbook, and so on.

Computing device 102 may also be implemented as any type of mobile device, such as a mobile phone, portable music player, portable gaming device, a tablet computer, a multi-screen computer, and so on. Computing device 102 may also be implemented as any type of television device having or connected to generally larger screens in casual viewing environments. These devices include televisions, set-top boxes, gaming consoles, and so on. The techniques described herein may be supported by these various configurations of the computing device and are not limited to the specific examples described herein.

The cloud 208 includes and/or is representative of a platform 210 for adaptive content management services 212. The platform abstracts underlying functionality of hardware, such as server devices, and/or software resources of the cloud. The adaptive content management services may include applications and/or data that can be utilized while computer processing is executed on servers that are remote from computing device 102. For example, the adaptive content management may include various portions of adaptive content management system 114 of FIG. 1. The adaptive content management services 212 can be provided as a service over the Internet and/or through a subscriber network, such as a cellular or WiFi network.

The platform 210 may abstract resources and functions to connect computing device 102 with other computing devices. The platform may also serve to abstract scaling of resources to provide a corresponding level of scale to encountered demand for the services that are implemented via the platform. Accordingly, in an interconnected device embodiment, implementation of functionality of the adaptive content management system 114 may be distributed throughout the system 200. For example, the adaptive content management system 114 may be implemented in part on computing device 102 as well as via the platform that abstracts the functionality of the cloud.

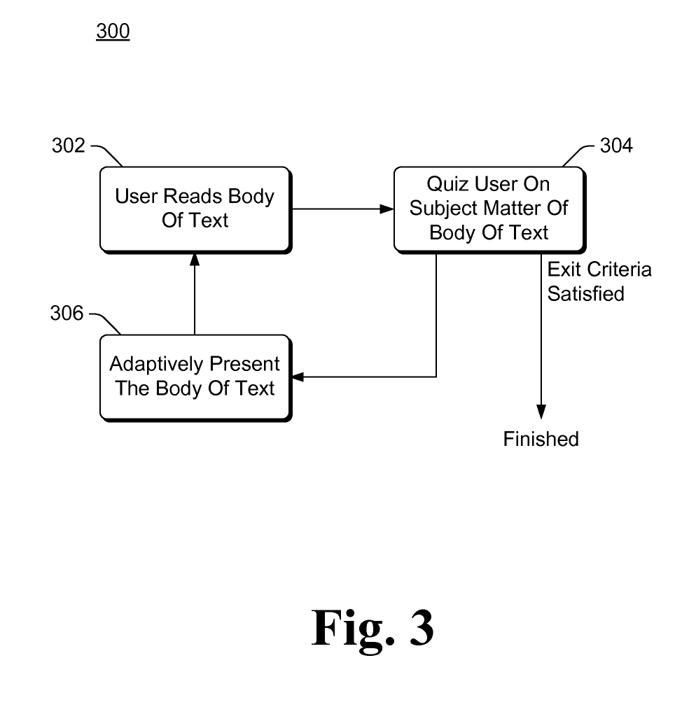

FIG. 3 illustrates an example flow diagram 300 for the adaptively presenting content based on user knowledge in accordance with one or more embodiments. Following flow diagram 300, a user reads (or listens to or otherwise consumes) a body of text at block 302. The user is quizzed on the subject matter of the body of text at block 304 by being presented with one or more questions that have been automatically generated based on the body of text. User inputs answering the questions are received, and the body of text is adaptively presented to the user at block 306. This flow can continue, with additional questions being automatically generated to focus on parts of the body of text that the user has not yet demonstrated (by way of his or her answers to the quiz questions) that he or she has mastered. Once the user has mastered the subject matter of the body of text (or alternatively other exit criteria are satisfied), this flow ends.

It should be noted that the flow illustrated in FIG. 3 can begin at block 302, with the user reading the body of text prior to being quizzed on the subject matter of the body of text. Alternatively, the flow illustrated in FIG. 3 can begin at block 304, with the user being quizzed on the subject matter of the body of text prior to reading the body of text.

The adaptively presenting content based on user knowledge discussed herein supports various usage scenarios. For example, a user can desire to learn about a particular subject matter. One or more articles regarding the subject matter are obtained and displayed to the user. The user reads the one or more articles and answers one or more questions automatically generated from the one or more articles. Based on the user's answers, one or more portions of the one or more articles that include subject matter the user has not yet mastered are identified, and the one or more articles can be presented to the user again with those portions that he or she has not yet mastered emphasized. The user can thus focus on those portions of the one or more articles he or she does not yet understand. This process can continue, with subsequent quizzes used to further focus the user on portions of the one or more articles that he or she does not yet understand.

By way of another example, a user may indicate a desire to read a particular one or more articles, and rather than first reading the one or more articles the user is presented with one or more questions automatically generated from the one or more articles. The user answers the questions, and based on the user's answers one or more portions of the one or more articles that include subject matter the user has not yet mastered are identified. The one or more articles are presented to the user with those portions that he or she has not yet mastered emphasized, providing a more efficient reading experience for the user because the user is notified of the parts of the one or more articles that he or she does not understand, and can read the one or more articles faster because he or she can simply read the parts of the one or more articles that he or she does not understand and can ignore the other parts of the one or more articles.

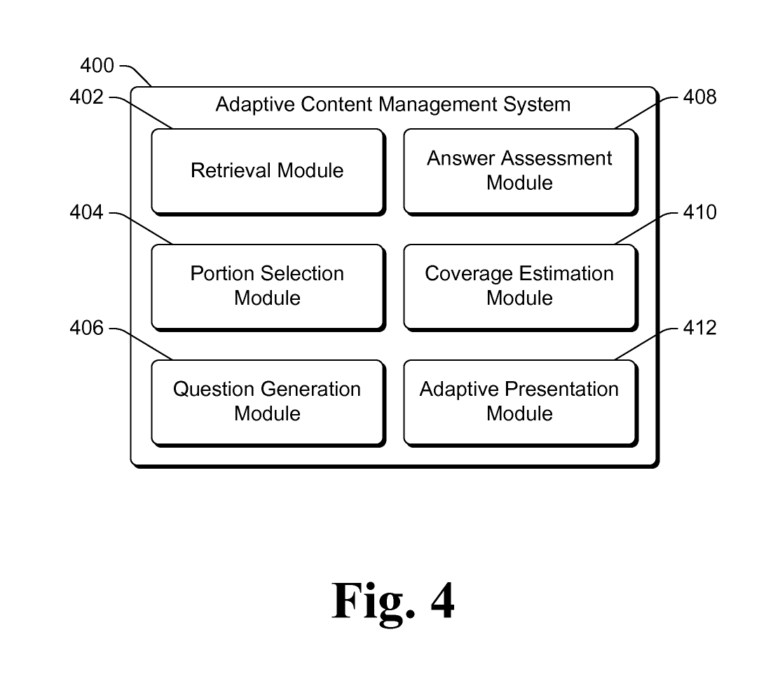

FIG. 4 illustrates an example adaptive content management system 400 in accordance with one or more embodiments. Adaptive content management system 400 can be, for example, an adaptive content management system 114 of FIG. 1 or FIG. 2. Adaptive content management system 400 can be implemented on a single device (e.g., computing device 102 of FIG. 1 or FIG. 2) or on multiple devices (e.g., computing device 102 and one or more devices of platform 210 of FIG. 2). Adaptive content management system 400 includes a retrieval module 402, a portion selection module 404, a question generation module 406, an answer assessment module 408, a coverage estimation module 410, and an adaptive presentation module 412.

Generally, retrieval module 402 obtains a body of text from a content source, such as content source 104 of FIG. 1. Portion selection module 404 automatically selects portions, such as sentences, of the body of text and question generation module 406 automatically generates and displays, based on the selected portions, questions regarding the subject matter of the body of text. Answer assessment module 408 receives user answers to the questions and determines the correctness of the user answers. Coverage estimation module 410 generates an estimate, based on the correctness of the user answers, of which parts of the body of text the user understands and which parts the user does not understand. Adaptive presentation module 412 presents at least part of the body of text with particular portions emphasized based on the estimate generated by module 410. This questioning and displaying of particular portions of the body of text with particular portions emphasized can optionally be repeated until a threshold level of mastery of the subject matter of the body of text has been demonstrated by the user.

Retrieval module 402 obtains a body of text from a content source. The body of text to be obtained can be identified in a variety of different manners. In one or more embodiments, the body of text is a set of one or more articles that are selected by the user. Alternatively, the body of text can be identified in other manners, such as identifying a set of one or more articles generated from search results (e.g., resulting from user provided search terms or criteria), text recognized from an audio recording, text recognized from an audio/video recording, and so forth.

An article as discussed herein can be any text item, such as a news article, a magazine article, blog, other publication, and so forth. An article includes text, and can also include additional content. For example, an article can include images, video, audio, and so forth that can be presented when the text is presented.

Portion selection module 404 automatically selects portions of the body of text to be used as a basis for generating questions. As used herein, a portion is typically a sentence, although a portion can alternatively be other groupings of text. For example, rather than being a single sentence, a portion can alternatively be more than a sentence (e.g., any number of sentences) or less than a sentence (e.g., a phrase of a sentence).

Portion selection module 404 selects portions of the body of text that are expected to result in generation of good questions for testing a user's knowledge of the subject matter of the body of text. The subject matter of the body of text refers to the subject matter that the body of text is covering or describing. Portion selection module 404 can select portions of the body of text in a variety of different manners.

In one or more embodiments, portion selection module 404 implements a summarization technique to select portions of the body of text. A summarization technique selects portions of a body of text to include in a summary of the body of text. Portion selection module 404 can identify these portions selected by the summarization technique as portions of the body of text that are expected to result in generation of good questions for testing a user's knowledge of the subject matter of the body of text. Various different known summarization techniques can be used in portion selection module 404, such as the technique discussed in A. Nenkova and L. Vanderwende, “The Impact of Frequency on Summarization”, Technical Report, January 2005.

In one or more embodiments, portion selection module 404 implements a classifier trained on human judgments of portion importance for quizzing a subject to select portions of the body of text. The classifier can be trained in a variety of different manners based on a variety of different features. For example, a training set including multiple bodies of text can be used to train the classifier. The training set can be selected in different manners, such as by selecting a large existing corpus of newspaper or encyclopedia articles, selecting a specialized set of articles, based on input from a human user, and so forth. Two portions from a body of text in the training set are presented to one or more human judges that identify which of the two portions include better information (from the human judge's viewpoint) for a question. For example, the two portions can be presented to the human judges, and the human judges asked to identify which of the two portions contain information the human judges would ask about first when questioning someone regarding the subject matter of the body of text in the training set.

Given multiple (e.g., on the order of thousands of or tens of thousands of) such judgments for multiple pairs of portions, the classifier is trained using features of the portions. Various different features can be used to train the classifier as discussed in more detail below. The classifier can be trained using various different conventional techniques, such as logistic regression.

Alternatively, rather than questioning the human judges regarding which of two portions includes better information (from the human judge's viewpoint) and training the classifier based on the responses of the human judges, the human judges can be questioned in different manners and the classifier trained on the responses to the questions. For example, the human judges can be asked to assign a ranking (e.g., a value 1 to 10, or a letter grade A to F) to each of multiple questions, can be asked to reorder three or more questions in order (e.g., in order from most likely to be asked when questioning someone regarding the subject matter of the body of text to least likely to be asked), and so forth.

Once trained, the classifier can use the various features of an arbitrary body of text to rank portions of the arbitrary body of text by generating pairwise judgments between the portions of the arbitrary body of text. For each pairwise judgment, a determination is made as to which portion is determined by the classifier as being a better question (e.g., being viewed as having a higher importance or being more important) for testing a user's knowledge of the subject matter of the arbitrary body of text than the other portion in the pairwise judgment, and that portion is referred to as winning that pairwise judgment. The portions can then be ranked in accordance with how many pairwise judgments the portions won, and the highest ranked portions (the portions having won the most pairwise judgments) are selected as the portions of the arbitrary body of text that are expected to result in generation of good questions for testing a user's knowledge of the subject matter of the arbitrary body of text. Each portion can also be assigned a ranking value indicating its rank relative to the other portions (e.g., the ranking value for a portion can be a count of the number of pairwise judgments the portion won). Alternatively, the rankings can be used to select which portions of the arbitrary body of text are expected to result in generation of good questions for testing a user's knowledge of the subject matter of the arbitrary body of text in other manners, such as using the techniques discussed in N. Ailon and M. Mohri, “An Efficient Reduction of Ranking to Classification”, New York University Technical Report (2007).

Table I illustrates examples of features that can be used by a classifier implemented in portion selection module 404. It should be noted that the features in Table I are examples, and that not all of the features included in Table I need be used by a classifier implemented in portion selection module 404. It should also be noted that additional features not included in Table I can also be used by a classifier implemented in portion selection module 404.

TABLE I

| Feature | Description |
|---|---|
| Summary | A score for the portion generated using a summarization |
| score | technique. |
| Portion length | A length (e.g., in words) of the portion. |
| Noun/pronoun | A percentage of the words in the portion that are nouns |
| density | and/or pronouns. |
| Named entity | A percentage of the words in the portion that are named |
| density | entities (e.g., names of individuals, names of companies, |
| | names of locations, etc.). |
| Title matching | A percentage of the words in the portion that match (are |
| density | the same as) words in a title of the body of text. |
| Body depth | A number of portions into the body of text, from the |
| | beginning of the body of text, that the portion is (e.g., the |
| | portion is the 4^{th} portion or 27^{th} portion of the body |
| | of text). |
| Section depth | If the body of text includes multiple sections, a number |
| | of sections into the body of text, from the beginning of the |
| | body of text, that the portion is included in (e.g., the |
| | portion is included in the 1^{st} section or the 5^{th} section |
| | of the body of text). |
| Body title | A count of how many of the words in the portion match |
| word match | (e.g., are the same as or have a same root or base as) |
| counts | words in a title of the body of text. |
| Section header | If the body of text includes multiple sections, a count |
| word match | of how many of the words in the portion match (e.g., are |
| counts | the same as or have a same root or base as) words in a |
| | section header of the body of text. |
| Link density | A percentage of the words in the portion that are links |
| | to other content (e.g., Web pages). |

Different techniques such as summarization techniques and classifiers are discussed as being used by portion selection module 404 to automatically select portions of the body of text. However, it should be noted that portion selection module 404 can use various other automated methods or techniques to automatically select portions of the body of text, such as a regressor, first-order logic, a set of rules or heuristics, and so forth.

Question generation module 406 automatically generates, based on the selected portions identified by portion selection module 404, one or more questions regarding the subject matter of the body of text. In one or more embodiments, one or more of the selected portions identified by portion selection module 404 are each used as a basis for generating a question. These questions are presented to the user, and one or more user inputs indicating user answers to the questions are received.

In one or more embodiments, question generation module 406 includes a classifier trained on human judgments of question quality from multiple questions. These questions can be short-answer questions for which a user enters a short-answer response, such as a fill-in-the-blank question.

To train the classifier, a portion training set including portions generated by portion selection module 404 is generated. This portion training set can be portions identified from the same training set of bodies of text used to train a classifier of module 404, or alternatively portions selected by module 404 from other bodies of text. Question generation module 406 selects a portion from the portion training set and generates multiple fill-in-the-blank questions. These fill-in-the-blank questions can be generated in different manners, such as by using any of various well-known natural language processing techniques to identify possible meaningful blanks (e.g., words or phrases that have substantive meaning for the subject matter of the body of text including the portion). For example, different fill-in-the-blank questions can be generated, each having a different noun, pronoun, verb, etc. left as a blank, and the word or phrase that is left as a blank is the correct answer to the question.

The multiple different fill-in-the-blank questions are presented to one or more human judges that rank how good of a question (from the human judge's viewpoint) each question is. For example, a fill-in-the-blank question can be presented and the human judge can be asked to identify whether the question is rated as “good”, “okay”, or “bad”, to identify a score ranging from 1 (being terrible) to 10 (being excellent), and so forth.

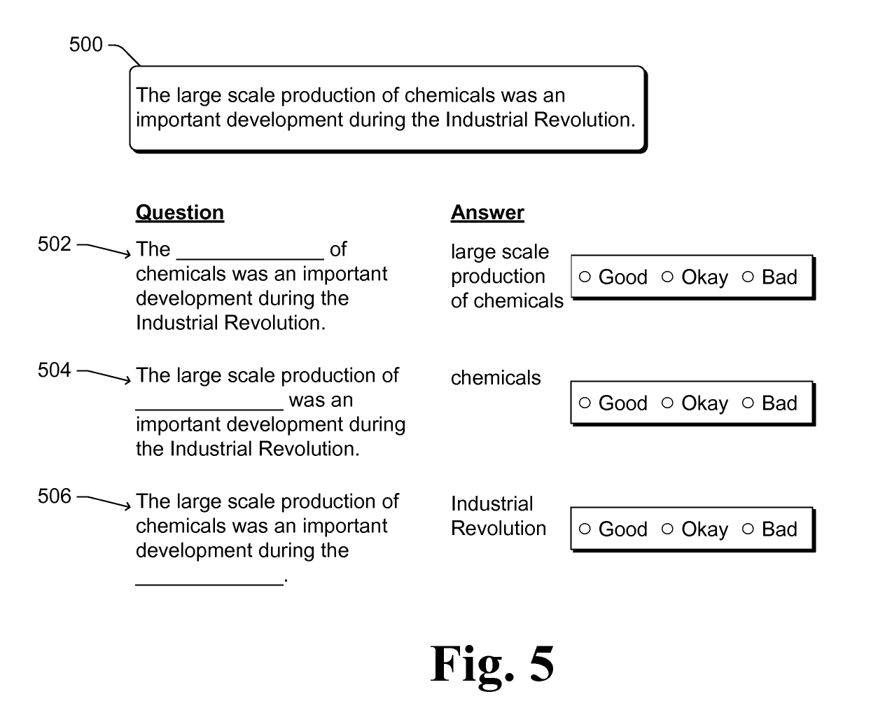

FIG. 5 illustrates an example of fill-in-the-blank questions that can be presented to one or more human judges in accordance with one or more embodiments. A portion 500 from the portion training set is selected and multiple fill-in-the-blank questions 502, 504, and 506 are generated. The questions, as well as correct answers, are presented to the one or more human judges, which provide an input for each question 502, 504, and 506 as to whether the question is “good”, “okay”, or “bad”.

Returning to FIG. 4, given multiple (e.g., on the order of thousands of or tens of thousands of) such judgments for multiple questions, the classifier is trained using features of the questions. Various different features can be used to train the classifier as discussed in more detail below. The classifier can be trained using various different conventional techniques, such as logistic regression.

Although discussed with reference to short-answer fill-in-the-blank questions, it should be noted that question generation module 406 can alternatively automatically generate other types of questions, such as multiple-choice questions, essay questions, and so forth. Module 406 can implement a classifier trained for these other types of questions, using various features analogous to the discussion above.

Once the classifier is trained, question generation module 406 can generate various questions (e.g., fill-in-the-blank questions) as discussed above for the arbitrary body of text, and the classifier can use the various features of each generated question to rank the questions (and optionally produce a score for the questions). The questions can be ranked in different manners, such as ranked “good”, “okay”, or “bad”, scored as values ranging from 1 (terrible) to 10 (excellent), and so forth.

Given the rankings of different questions for an arbitrary body of text, a quiz regarding the arbitrary body of text can be generated having any number of questions. For example, all questions (or at least a threshold number of questions) ranked as “good” can be included in a quiz regarding the subject matter of the arbitrary body of text that is presented to a user. By way of another example, all questions (or at least a threshold number of questions) having higher than a threshold score (e.g., 8 or higher) can be included in a quiz regarding the subject matter of the arbitrary body of text that is presented to a user.

Alternatively, rather than asking the human judges to assign a rating of “good”, “okay”, or “bad”, or a numeric score, to the questions and training the classifier based on the responses of the human judges, the human judges can be asked to identify how good of a question (from the human judge's viewpoint) each question is in different manners and the classifier can be trained based on the responses of the human judges. For example, the human judges can be asked to reorder three or more questions in order of quality (e.g., in order from being a good question to being a bad question from the human judge's viewpoint), the human judges can be asked which of two questions is a better question (from the human judge's viewpoint) for testing the subject matter of a body of text, and so forth.

Table II illustrates examples of features that can be used by a classifier implemented in question generation module 406. It should be noted that the features in Table II are examples, and that not all of the features included in Table II need be used by a classifier implemented in question generation module 406. It should also be noted that additional features not included in Table II can also be used by a classifier implemented in question generation module 406. In the descriptions of Table II, references to the “answer” refer to the correct answer (e.g., as identified by question generation module 406 when presenting the question to the one or more human judges), and references to the “portion” refer to the portion from which the question is generated.

TABLE II

| Feature | Description |
|---|---|
| Number of words | A count of a number of words in the answer. |
| in answer | |
| Percent of | A percentage of the number of words in the portion |
| portion's words in | that are included in the answer. |
| answer | |
| Number of words | A count of a number of words included in the answer |
| in answer | that match (e.g., are the same as or have a same root or |
| matching words | base as) words in the portion that are not in the |
| outside of answer | answer. |
| Answer pronoun | A percentage of the words in the answer that are |
| density | pronouns. |
| Answer | A percentage of the words in the answer that are |
| abbreviation | abbreviations. |
| density | |
| Answer capital- | A percentage of the words in the answer that |
| ized word density | are capitalized. |
| Answer stopword | A percentage of the words in the answer that belong |
| density | to a particular (e.g., predefined) “stop word” list, |
| | such as prepositions, articles, pronouns, high |
| | frequency words (e.g., “be”, “have”, “take”), and |
| | so forth. |
| Answer quantifier | A percentage of the words in the answer that are |
| density | quantifiers (e.g., “all”, “many”, “some”, etc.). |
| Percent pronouns | A percentage of the pronouns in the portion that are |
| in answer | included in the answer. |
| Link density in | A percentage of the words in the answer that are |
| answer | links to other content (e.g., Web pages). |
| Part of speech | One or more parts of speech in the portion preceding |
| before answer | the answer. |
| Part of speech in | One or more parts of speech in the answer. |
| answer | |
| Part of speech | One or more parts of speech in the portion |
| after answer | following the answer. |
| Named entity | A percentage of the words in the answer that are |
| density | named entities. |
| Named entity | A count of a number of words included in the answer |
| word counts | that are named entities. |
| Named entity | Types (e.g., person names, company names, |
| types | location names, etc.) of the named entities in the |
| | answer. |
| Semantic Role | Types of the semantic roles that the words in the |
| Labels covering | answer function as (semantic role labels such as |
| the answer | “agent”, “patient”, “recipient”, etc.). |
| Semantic Role | Types of the semantic roles that include the words |
| Labels contain- | in the answer. |
| ing the answer | |
| Parse depth | A number of words into the portion, from the |
| | beginning of the body of text, at which the answer |
| | begins (e.g., the answer beings at the 3^{rd} word or 7^{th} |
| | word of the portion). |
| Answer | Whether the answer is included in quotes. |
| surrounded by | |
| quotes | |
| Answer in | Whether the answer is included in parenthesis. |
| parenthesis | |

Particular techniques such as a classifier trained on human judgments of question quality are discussed as being used by question generation module 406 to automatically generate questions. However, it should be noted that question generation module 406 can use various other automated methods or techniques to automatically generate questions, such as a regressor, first-order logic, a set of rules or heuristics, and so forth.

Answer assessment module 408 receives user answers to the questions and determines the correctness of the user answers. User inputs that are answers to the questions presented by question generation module 406 are received by answer assessment module 408. Answer assessment module 408 can determine the correctness of these received answers using one or more of a variety of different techniques.

In one or more embodiments, answer assessment module 408 uses a self-assessment technique to determine the correctness of received answers. Using the self-assessment technique, module 408 presents both the correct answers for the questions and the user input answers for the questions. The user is then prompted to indicate whether the answer he or she input is accurate. User inputs of the correctness of the received answers are received by answer assessment module 408, allowing module 408 to readily identify which questions the user answered correctly and which questions the user answered incorrectly.

Additionally, or alternatively, answer assessment module 408 uses a crowdsourcing technique to determine the correctness of received answers. Using the crowdsourcing technique, module 408 provides both the correct answers for the questions and the user input answers for the questions to a service that allows other people (other than the person that answered the question) to determine the correctness of the answers. The other people that determine the correctness of the answers can be various people that access the service, such as people that subscribe to the service, people that receive payment (e.g., in real-world cash or credit, in an in-game or in-service cash or credit, etc.), people that have previously used the service to have the correctness of answers on their quizzes determined, and so forth. One or more of these other people are prompted to indicate whether the answer the user input is accurate. The service receives user inputs indicating a correctness of the answers provided by the user. Answer assessment module 408 receives an indication of the correctness of the received answers from the service, allowing module 408 to readily identify which questions the user answered correctly and which questions the user answered incorrectly.

Additionally, or alternatively, answer assessment module 408 uses an automatic assessment technique to determine the correctness of received answers. The automatic assessment technique can be implemented in various manners. For example, if questions are multiple choice questions or if a user input answer is correct only if it is identical to the correct answer for the question, then module 408 can compare the user input answer to the correct answer and readily identify which questions the user answered correctly and which questions the user answered incorrectly.

Answer assessment module 408 can also implement a classifier trained on human judgments of whether answers are correct or incorrect. To train the classifier, questions (e.g., questions automatically generated by question generation module 406 during training of a classifier implemented in question generation module 406) are presented to various human testers and tester input answers from these human testers are received. One or more human judges (which can be the human testers or other individuals) also provide a judgment of whether (from the human judge's viewpoint) each tester input answer is acceptable or unacceptable. An answer training set includes both the correct answers for the questions and the user input answers for the questions, as well as the indication of whether the input answer is acceptable or unacceptable.

Given multiple (e.g., on the order of thousands of or tens of thousands of) such judgments for multiple answers, the classifier is trained using features of the answers. Various different features can be used to train the classifier as discussed in more detail below. The classifier can be trained using various different conventional techniques, such as logistic regression. Once trained, the classifier can use the various features of a user input answer and/or the correct answer to determine the correctness of the user input answer, allowing answer assessment module 408 to readily identify which questions the user answered correctly and which questions the user answered incorrectly for an arbitrary body of text.

Table III illustrates examples of features that can be used by a classifier implemented in answer assessment module 408. It should be noted that the features in Table III are examples, and that not all of the features included in Table III need be used by a classifier implemented in answer assessment module 408. It should also be noted that additional features not included in Table III can also be used by a classifier implemented in answer assessment module 408.

TABLE III

| Feature | Description |
|---|---|
| String edit | A count of a number of editing operations (e.g., add, |
| distance | remove, etc.) it takes to make the user input answer |
| | identical to the correct answer. |
| Synonym | A count of how many words in the user input answer |
| scores | are synonyms of the correct answer. |
| Database | A distance between words in the user input answer |
| distances | and words in the correct answer (how many jumps from |
| | word to word are taken to get to a word in the correct |
| | answer from the user input answer) in a database of |
| | meaningfully related words and concepts. An example |
| | of such a database is the WordNet lexical database |
| | available from Princeton University at |
| | “wordnet.princeton.edu”. |
| Textual | Whether the user input answer subsumes the |
| entailment | correct answer. |

Particular techniques such as a classifier trained on human judgments of whether answers are acceptable or unacceptable are discussed as being used by answer assessment module 408 to determine the correctness of answers. However, it should be noted that answer assessment module 408 can use various other automated methods or techniques to determine the correctness of answers, such as a regressor, first-order logic, a set of rules or heuristics, and so forth.

Coverage estimation module 410 generates an estimate, based on the correctness of the user answers, of user mastery of various portions of the body of text (the user is deemed to have mastery of the parts of the body of text that the user is estimated as understanding, and is deemed to not have mastery of the parts of the body of text that the user is estimated as not understanding). A user may understand subject matter from certain parts of the body of text well, but not understand subject matter from other parts as well. Coverage estimation module 410 attempts to identify those portions of the body of text that the user does not have mastery of so that those parts can be emphasized to the user, as discussed in more detail below.

Coverage estimation module 410 can estimate which portions of the body of text the user has mastered and which parts the user has not mastered in various manners. This estimate can be a probability of the user having mastery of the subject matter of each of multiple portions of the body of text, or alternatively other scores or estimates indicating whether the user has mastery of the subject matter of each of multiple portions of the body of text. In one or more embodiments, a probability of the user having mastery of the subject matter of a particular portion is determined based on the portions for which questions were answered by the user, the correctness of those answers, and the distance of the particular portion from those portions for which questions were answered by the user. For each portion from which a question is generated, a probability of whether the user has mastered the subject matter of each other portion of the body of text is generated. This probability is generated based on a number of portions of the body of text separating the portion from the portion from which the question is generated, as well as whether the user input answer was correct. The probability can be assigned in various manners based on the desires and/or observations of a designer of coverage estimation module 410, and can vary from 0 (has not mastered) to 1.0 (has mastered).

For example, if the user answer to a question generated from a portion S in the body of text is correct, then the probability of the user having mastered the subject matter of the preceding portion (S−1) and the subsequent portion (S+1) can be 0.75, the probability of the user having mastered the subject matter of the portion two portions before (S−2) and the portion two portions after (S+2) can be 0.5, and so forth. By way of another example, if the user answer to a question generated from a portion S in the body of text is incorrect, then the probability of the user having mastered the subject matter of the preceding portion (S−1) and the subsequent portion (S+1) can be 0.1, the probability of the user having mastered the subject matter of the portion two portions before (S−2) and the portion two portions after (S+2) can be 0.4, and so forth.

The probabilities for each of multiple portions of the body of text can be generated based on each portion from which a question was generated for and answered by the user. For each of the multiple portions, a score can be determined based on these probabilities generated for the portion in various manners. For example, the probabilities can be summed together and divided by the number of questions answered by the user. This score provides an indication, for each of the multiple portions, of whether (e.g., an estimated probability of whether) the user has mastered the subject matter of the portion. It should be noted that such probabilities and scores are generated for each of multiple portions of the body of text from which a question was not generated by question generation module 406 and answered by the user. For the portions from which a question was generated by question generation module 406 and answered by the user, whether the user has mastered the subject matter of the portion is already known based on the user input answer.

Additionally, or alternatively, coverage estimation module 410 can implement a classifier or regressor trained on whether answers are correct or incorrect, and assign a probability to each of multiple portions of the body of text based on various features as discussed below rather than simply on a number of portions of the body of text separating the portion from the portion from which the question is generated. To train the classifier, a probability training set including both the one or more questions and the correctness of user answers to those one or more questions is generated. These questions can be the same questions used to train the classifier implemented in answer assessment module 408, or alternatively questions generated by question generation module 406 during training of a classifier included in module 406 but not used to train the classifier implemented in answer assessment module 408.

Given multiple (e.g., on the order of thousands of or tens of thousands of) such questions and correctness of user answers to those questions, the classifier is trained using features of the portions. Various different features can be used to train the classifier as discussed in more detail below. The classifier can be trained using various different conventional techniques, such as logistic regression. Once trained, the classifier can use the various features of a portion selected by portion selection module 404 from an arbitrary body of text, as well as the portions from which questions have been generated by question generation module 406 and answered by the user, to predict whether the user would correctly answer a question concerning the selected portion, and thus to determine a probability of the user understanding the subject matter of the portion.

Table IV illustrates examples of features that can be used by a classifier implemented in coverage estimation module 410. It should be noted that the features in Table IV are examples, and that not all of the features included in Table IV need be used by a classifier implemented in coverage estimation module 410. It should also be noted that additional features not included in Table IV can also be used by a classifier implemented in coverage estimation module 410. Table IV refers to a target portion and a probe portion. The probe portion refers to a portion of a body of text from which a question has been generated by question generation module 406 and answered by the user, and the target portion refers to an additional portion of the body of text for which a probability of the user understanding the subject matter of the additional portion is being determined.

TABLE IV

| Feature | Description |
|---|---|
| Distance between | A count of a number of portions in the body of |
| the portions | text between the probe portion and the target |
| | portion. |
| Number of | A count of a number of paragraph boundaries in |
| paragraph bound- | the body of text between the probe portion and |
| aries between | the target portion. |
| the portions | |
| Number of section | A count of a number of section boundaries in the |
| boundaries between | body of text between the probe portion and the |
| the portions | target portion. |
| Textual entailment | Whether the probe portion subsumes the |
| | target portion. |

Particular techniques such as a classifier or regressor trained on whether answers are correct or incorrect are discussed as being used by coverage estimation module 410 to generate an estimate of user mastery of various portions of the body of text. However, it should be noted that coverage estimation module 410 can use various other automated methods or techniques to generate an estimate of user mastery of various portions of the body of text, such as first-order logic, a set of rules or heuristics, and so forth.

Adaptive presentation module 412 presents the body of text adapted to the particular user based on his or her knowledge of the subject matter of the body of text (as determined by coverage estimation module 410). The body of text is adapted to the user by presenting at least part of the body of text so that particular portions of the body of text are emphasized based on the estimate generated by module 410. The particular portions can be emphasized in various manners. For example, portions of the body of text having an estimated probability of having been mastered by the user of less than a particular threshold can be presented to the user, but other portions of the body of text not presented to the user. By way of another example, all of the body of text can be presented and portions of the body of text having an estimated probability of having been mastered by the user of less than a particular threshold can be highlighted, underlined, displayed in a different font or color, and so forth. By way of another example, parts (e.g., sections or subsections) of the body of text having at least one portion having an estimated probability of having been mastered by the user of less than a particular threshold can be presented, and portions of the body of text having an estimated probability of having been mastered by the user of less than a particular threshold can be highlighted, underlined, displayed in a different font or color, and so forth.

In addition to emphasizing particular portions of the body of text, additional bodies of text can be presented to the user. For example, additional bodies of text related to the subject matter of one or more of the particular portions being emphasized can be obtained and presented to the user, providing additional content from which the user can learn the subject matter of those one or more particular portions.

The generation of questions, assessment of answers, estimation of coverage, and adaptive presentation of the body of text can be repeated one or more times. Each time, portion selection module 404 selects portions of the body of text, from which question generation module 406 generates questions, in an attempt to focus the questions on portions of the body of text that the user has not mastered. This selection of portions can be performed in different manners. For example, the portions can be selected from those portions having an estimated probability of having been mastered by the user of less than a particular threshold rather than selecting the portions from the entire body of text. By way of another example, the portions can be selected from parts (e.g., section or subsections) of the body of text having at least one portion having a probability of having been mastered by the user of less than a particular threshold rather than selecting the portions from the entire body of text. By way of yet another example, the portions can be assigned scores as discussed above with respect to portion selection module 404, and these scores can be weighted by multiplying the score value (e.g., ranging from 1 to 10) by an estimated probability that the user has not mastered the portion (e.g., a value equal to 1 minus the estimated probability that the user has mastered the portion). The portions having the largest weighted scores can be selected as the portions.

In one or more embodiments, the generation of questions, assessment of answers, estimation of coverage, and adaptive presentation of the body of text is repeated until particular exit criteria are satisfied. Different exit criteria can be used, such as a user request to exit, an estimated probability of mastery of each portion of the body of text by the user exceeding a particular threshold, an estimated probability of mastery of at least a threshold number of portions of the body of text by the user exceeding a particular threshold, and so forth.

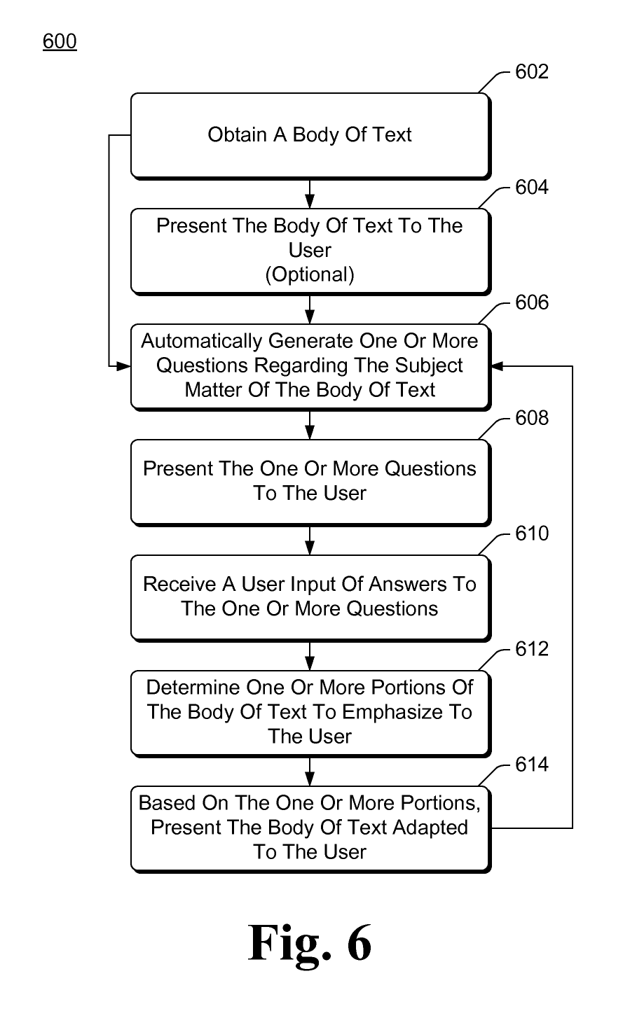

FIG. 6 is a flowchart illustrating an example process 600 for adaptively presenting content based on user knowledge in accordance with one or more embodiments. Process 600 is carried out by a system, such as adaptive content management system 400 of FIG. 4, and can be implemented in software, firmware, hardware, or combinations thereof. Process 600 is shown as a set of acts and is not limited to the order shown for performing the operations of the various acts. Process 600 is an example process for adaptively presenting content based on user knowledge; additional discussions of adaptively presenting content based on user knowledge are included herein with reference to different figures.

In process 600, a body of text is obtained (act 602). The body of text can be obtained in a variety of different manners as discussed above.

The body of text can optionally be presented to the user (act 604). Alternatively, process 600 can proceed to act 606 to generate one or more questions regarding the subject matter of the body of text without having presented the body of text to the user as discussed above.

One or more questions regarding the subject matter of the body of text are automatically generated (act 606). These questions can be automatically generated using a classifier or other automatic methods as discussed above.

The one or more questions generated in act 606 are presented to the user (act 608). Various types of questions can be displayed or otherwise presented to the user as discussed above.

A user input of answers to the one or more questions are received (act 610). Different types of user inputs can be received and these user inputs can vary based on the types of questions as discussed above.

One or more portions of the body of text to emphasize to the user are determined (act 612). These one or more portions are determined based on an estimated probability of user mastery of the various portions of the body of text as discussed above.

Based on the one or more portions, the body of text is presented adapted to the user (act 614). The body of text can be presented adapted to the user in various manners, such as highlighting particular portions or presenting only part of the body of text as discussed above.

Process 600 can repeat acts 606-614 one or more times until exit criteria are satisfied. These exit criteria can be a threshold level of user mastery of the subject matter being demonstrated by the user, such as by the estimated probability of user mastery of each portion of the body of text exceeding a particular threshold or by the estimated probability of user mastery of at least a threshold number of portions of the body of text exceeding a particular threshold as discussed above.

Various actions such as communicating, receiving, sending, generating, obtaining, and so forth performed by various modules are discussed herein. A particular module discussed herein as performing an action includes that particular module itself performing the action, or alternatively that particular module invoking or otherwise accessing another component or module that performs the action (or performs the action in conjunction with that particular module). Thus, a particular module performing an action includes that particular module itself performing the action and/or another module invoked or otherwise accessed by that particular module performing the action.

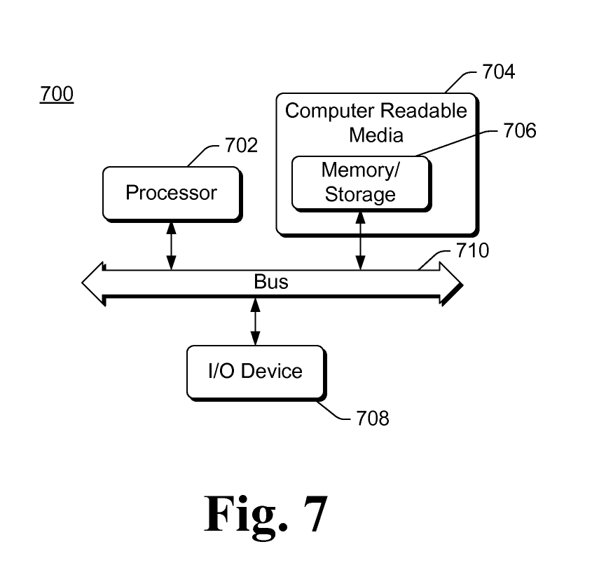

FIG. 7 illustrates an example computing device 700 that can be configured to implement the adaptively presenting content based on user knowledge in accordance with one or more embodiments. Computing device 700 can be, for example, computing device 102 of FIG. 1 or FIG. 2, or can be a device implementing at least part of platform 210.

Computing device 700 includes one or more processors or processing units 702, one or more computer readable media 704 which can include one or more memory and/or storage components 706, one or more input/output (I/O) devices 708, and a bus 710 that allows the various components and devices to communicate with one another. Computer readable media 704 and/or one or more I/O devices 708 can be included as part of, or alternatively may be coupled to, computing device 700. Processor 702, computer readable media 704, one or more of devices 708, and/or bus 710 can optionally be implemented as a single component or chip (e.g., a system on a chip). Bus 710 represents one or more of several types of bus structures, including a memory bus or memory controller, a peripheral bus, an accelerated graphics port, a processor or local bus, and so forth using a variety of different bus architectures. Bus 710 can include wired and/or wireless buses.

Memory/storage component 706 represents one or more computer storage media. Component 706 can include volatile media (such as random access memory (RAM)) and/or nonvolatile media (such as read only memory (ROM), Flash memory, optical disks, magnetic disks, and so forth). Component 706 can include fixed media (e.g., RAM, ROM, a fixed hard drive, etc.) as well as removable media (e.g., a Flash memory drive, a removable hard drive, an optical disk, and so forth).

The techniques discussed herein can be implemented in software, with instructions being executed by one or more processing units 702. It is to be appreciated that different instructions can be stored in different components of computing device 700, such as in a processing unit 702, in various cache memories of a processing unit 702, in other cache memories of device 700 (not shown), on other computer readable media, and so forth. Additionally, it is to be appreciated that the location where instructions are stored in computing device 700 can change over time.

One or more input/output devices 708 allow a user to enter commands and information to computing device 700, and also allows information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, applications, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media” and “communication media.”

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer. Computer storage media refer to media for storage of information in contrast to mere signal transmission, carrier waves, or signals per se. Thus, computer storage media refers to non-signal bearing media, and is not communication media.

“Communication media” typically embody computer readable instructions, data structures, program modules, or other data in a modulated data signal, such as carrier wave or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above are also included within the scope of computer readable media.

Generally, any of the functions or techniques described herein can be implemented using software, firmware, hardware (e.g., fixed logic circuitry), manual processing, or a combination of these implementations. The terms “module” and “component” as used herein generally represent software, firmware, hardware, or combinations thereof. In the case of a software implementation, the module or component represents program code that performs specified tasks when executed on a processor (e.g., CPU or CPUs). The program code can be stored in one or more computer readable memory devices, further description of which may be found with reference to FIG. 7. In the case of hardware implementation, the module or component represents a functional block or other hardware that performs specified tasks. For example, in a hardware implementation the module or component can be an application-specific integrated circuit (ASIC), field-programmable gate array (FPGA), complex programmable logic device (CPLD), and so forth. The features of the adaptively presenting content based on user knowledge techniques described herein are platform-independent, meaning that the techniques can be implemented on a variety of commercial computing platforms having a variety of processors.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
obtaining a body of text to be taught to a user;
automatically generating one or more questions regarding subject matter of the body of text;
presenting, to the user, the one or more questions;
receiving a user input of one or more answers to the one or more questions;
determining, based on a correctness of the one or more answers, one or more portions of the body of text to emphasize to the user; and
presenting, to the user, at least part of the body of text with the one or more portions being emphasized.

2. A method as recited in claim 1, the determining comprising identifying, as the one or more portions, at least one portion of the body of text that includes subject matter that the user is estimated to have less than a threshold probability of understanding.

3. A method as recited in claim 2, further comprising repeating the presenting the one or more questions or presenting new questions, the receiving, the determining, and the presenting at least part of the body of text until a threshold level of user mastery of the subject matter has been demonstrated.

4. A method as recited in claim 2, further comprising:
presenting, to the user, an additional one or more questions;
receiving an additional user input of an additional one or more answers to the additional one or more questions;
determining, based on the correctness of the one or more answers and a correctness of the additional one or more answers, an additional one or more portions of the body of text to emphasize to the user; and
presenting, to the user, at least part of the body of text with the additional one or more portions being emphasized.

5. A method as recited in claim 2, the automatically generating one or more questions comprising automatically generating the one or more questions from a first set of portions of the body of text, the method further comprising:
estimating, based on the correctness of the one or more answers, a probability of user mastery of the first set of portions;
estimating, based on the correctness of the one or more answers, a probability of user mastery of a second set of portions of the body of text that are separate from the first set of portions; and
the determining comprising determining, based on the probability of user mastery of the first set of portions and the probability of user mastery of the second set of portions, whether to emphasize the second set of portions to the user.

6. A method as recited in claim 1, further comprising performing, prior to presenting the body of text, the obtaining, the automatically generating, the presenting the one or more questions, and the determining.

7. A method as recited in claim 1, further comprising presenting, to the user, the body of text prior to presenting the one or more questions.

8. A method as recited in claim 1, the automatically generating one or more questions comprising automatically generating the one or more questions from a first set of portions of the body of text, the method further comprising automatically identifying the first set of portions.

9. A method as recited in claim 8, the automatically identifying the first set of portions comprising automatically identifying the first set of portions based on a classifier trained on human judgments of portion importance for quizzing a subject.

10. A method as recited in claim 1, the automatically generating one or more questions comprising:
selecting a first set of portions of the body of text; and
automatically generating the one or more questions based on both the first set of portions and an automatic method for generating questions.

11. A method as recited in claim 1, the presenting at least part of the body of text with the one or more portions being emphasized comprising presenting the one or more portions of the body of text but not other portions of the body of text.

12. A method as recited in claim 1, the presenting at least part of the body of text with the one or more portions being emphasized comprising displaying the body of text with the one or more portions highlighted.

13. One or more computer storage media having stored thereon multiple instructions that, when executed by one or more processors of a computing device, cause the one or more processors to:
present, to a user, one or more automatically generated questions regarding subject matter of a body of text;
receive a user input of one or more answers to the one or more automatically generated questions; and
present the body of text adapted, based on a correctness of the one or more answers, to the user.

14. One or more computer storage media as recited in claim 13, the multiple instructions causing the one or more processors to present the body of text adapted to the user further causing the one or more processors to display the one or more portions of the body of text but not other portions of the body of text or to display the body of text with the one or more portions highlighted.

15. One or more computer storage media as recited in claim 13, the multiple instructions further causing the one or more processors to determine, based on a correctness of the one or more answers, one or more portions of the body of text to emphasize to the user, the one or more portions including subject matter that the user is estimated to have less than a threshold probability of understanding.

16. One or more computer storage media as recited in claim 13, the one or more automatically generated questions having been generated from a first set of portions of the body of text, the multiple instructions further causing the one or more processors to automatically identify the first set of portions.

17. One or more computer storage media as recited in claim 13, the multiple instructions further causing the one or more processors to:
select a first set of portions of the body of text; and
automatically generate the one or more automatically generated questions based on both the first set of portions and an automated method for generating questions.

18. One or more computer storage media as recited in claim 13, the one or more automatically generated questions having been generated from a first set of portions of the body of text, the multiple instructions further causing the one or more processors to:
estimate, based on the correctness of the one or more answers, a probability of user mastery of the first set of portions;
estimate, based on the correctness of the one or more answers, a probability of user mastery of a second set of portions of the body of text that are separate from the first set of portions; and
present, as the body of text adapted to the user, the body of text adapted based on the probability of user mastery of the first set of portions and the probability of user mastery of the second set of portions.

19. One or more computer storage media as recited in claim 13, the multiple instructions further causing the one or more processors to present the one or more automatically generated questions and receive the user input prior to presenting the body of text to the user.

20. One or more computer storage media having stored thereon multiple instructions that, when executed by one or more processors of a computing device, cause the one or more processors to:
obtain a body of text to be taught to a user;
display the body of text to the user; and
repeatedly, until an estimated probability of user mastery of each portion of the body of text exceeds a first threshold or until user mastery of at least a threshold number of portions of the body of text exceeds a second threshold:
automatically generate one or more questions regarding subject matter of the body of text;
display, to the user, the one or more questions;
receive a user input of one or more answers to the one or more questions;
determine, based on a correctness of the one or more answers, one or more portions of the body of text that include subject matter that the user is estimated to have less than a threshold probability of understanding; and
display, to the user, at least part of the body of text with the one or portions being emphasized.
